(19) United States
(12) Patent Application Publication
(10) Pub. No.: US 2008/0305958 A1
(43) Pub. Date: Dec. 11, 2008

(54) Process for Liquid or gas Chromatography/Mass Spectrometry Based Biomolecular Screening for Drug Discovery

(76) Inventor: Mark Hayward, Stockton, NJ (US)

Correspondence Address: Lynn J Alstadt;BUCHANAN INGERSOLL & ROONEY, One Oxford Centre, 301 Grant Street 20th Floor, Pittsburgh, PA, 15219, US

(21) Appl. No.: 11/587,601

(22) PCT Filed: Apr. 29, 2005
(86) PCT No.: PCT/US05/14820

§ 371 Date: Oct. 27, 2006

Related U.S. Application Data
(60) Provisional application No. 60/566,679, filed on Apr. 30, 2004.

(51) Int. Cl. C40B 20/04; C40B 40/02

(52) U.S. Cl. 506/4; 506/14

(57) ABSTRACT

Methods of achieving realistic hit rates and reducing or eliminating false positive rates in medicinal compound high throughput screening are provided. The methods of the invention include chromatographic resolution, for example by liquid or gas chromatography of biological substrates and/or substrate products, followed by sensitive with mass spectrometry to measure biological activity screening to generate meaningful drug leads. The methods of the invention save significant method development and thus are directly applicable to the high throughput screening time scale while providing high accuracy and sensitivity.

### CROSS-REFERENCE TO RELATED APPLICATIONS

This application claims the benefit or priority of U.S. Provisional Application No. 60/566,679 filed Apr. 30, 2004, which is herein incorporated by reference in its entirety.

### FIELD OF THE INVENTION

The present invention relates generally to the field of drug discovery and high-throughput biomolecular screening for bioactive molecules and, more specifically, to improved methods for processing high numbers of compound library samples while obtaining more meaningful and useful data from high throughput screens to obtain novel therapeutics. The methods of the present invention result in higher specificity of hits, lower more realistic hit rates, and reduction or elimination of false-positives from biomolecular high-throughput screens of compound libraries.

### BACKGROUND OF THE INVENTION

Observing or measuring the activity or efficacy of compounds for potential therapeutic purposes is the backbone of drug discovery. High throughput screening of large numbers of compounds found in nature or synthesized for activity against potential therapeutic targets is a vital aspect of drug discovery and development.

The urgent need for high capacity screening of compound libraries to find therapeutic compound leads is evidenced by both increased high throughput methods for synthesizing (e.g. using combinatorial chemistry methods) and the development of automation and robots for screening large numbers of these compounds for desired biological and physico-chemical properties. Similarly, among the results of the human genome project has been a veritable deluge of sequence data from genes, which require rapid characterization of their protein products and elucidation of biological function as possible therapeutic targets. Finding compounds that affect the biological function of these protein products is an important step in understanding their function and potential as a therapeutic target.

Technology enhancement in high throughput biomolecular screening has frequently focused on automation and handling (or moving) more compounds faster. Thus, advances in high throughput screening often involve advances in microfluidics and other liquid handling techniques such as micropipetting, piezoelectric droplet dispensing, split pin dispensing, and microspritzing. However, these techniques also have limitations as they are not suitable for rapidly loading or transferring liquids to or from high density plates (e.g., plates having more than abut 384 wells). These techniques can also cause substantial splashing, resulting, for example, in contamination of neighboring wells and loss of sample volume. Also as the number of wells increases, the time necessary to reformat compounds from previous generation of plates to the higher density plates generally increases, thus limiting the utility of the higher density plates.

Other improvements that overcome the limitation of microfluidics are advances in high speed and handling of liquids that allow for high throughput screening as described in U.S. Pat. No. 6,716,629B2 ('629 patent) issued to Bio Trove, Inc. of Cambridge, Mass., U.S.A., herein incorporated by reference in its entirety. The methods of the '629 patent make use of improved methods for handling high numbers of samples for high throughput screening that solve the sample handling issues of previous methods but do not address improved screening accuracy methods to efficiently yield successful effective therapeutic drug leads. For example, BioTrove, Inc. uses a conveyor belt or tape system that is used to carry out the reaction of compound library samples to determine biological activity on the belt or tape itself, which poses serious problems for the continuous reaction process if one component fails resulting in the entire process failing. Also, because a biological reaction is carried out on a belt surface there may be problems of evaporation, variability of concentration of reagents, limitation of the time that a reaction can be incubated, among others.

One of the significant constraints in high throughput screening are the time required to development a measurement method. It is not unusual to spend six months or more to develop and validate the measurement method used to measure compound activity or efficiency in a high throughput screen. Thus, there exists an urgent need for faster ways to develop high throughput screening methods.

Despite the advances in technologies to assist in the handling of large numbers of samples for high throughput screening, there still exist limitations in the process that result in a large number of non-specific hits yielding unnaturally high rates consisting primarily of false-positive hits from biomolecular high-throughput screens of compound libraries. Because these false hits are taken into the next phases of drug discovery where they eventually prove unsuccessful, these false positive hits in turn lead to significantly higher research costs and longer research and development cycles for therapeutic compounds and ultimately do not yield successful efficacious therapeutics reaching the marketplace.

Thus, there exists a need for improved time-efficient methods of high throughput screening of synthetic and naturally occurring compounds that result in more realistic hit rates and greatly reduced false positive rates that shorten the drug research and development cycle to produce successful efficacious therapeutics. The unique approach of the methods of the present invention utilize fast separations to achieve greater molecular specificity in high throughput biomolecular screens to meet these and other needs as described below.

### SUMMARY OF THE INVENTION

The present invention provides, in one aspect, materials and methods to efficiently and effectively process large numbers of compound library samples for high throughput screening (HTS) for biological activity of drug candidates that result in realistic hit rates with reduction or elimination of false positive rates of potential therapeutic compound leads. The methods of the invention are adaptable to a variety of types of compounds with a variety of biological activities and screening methodologies.

In one embodiment, the invention provides methods to time-efficiently resolve each sample from compound library mixtures to be screened into its component compounds to determine specific biological activity of each component compound. Thus more realistic hit rates are achieved while reducing or eliminating false positive hit rates. In one embodiment, the resolution of compound library samples are performed at the “front end” before a reaction is performed to screen for biological activity.

In one embodiment, the invention provides methods to time-efficiently separate samples through chromatographic techniques to resolve the sample compound into its component parts to determine specific biological activity thus providing realistic hit rates and reducing or eliminating false positive hit rates. In one embodiment, the time-efficient separation is performed by liquid chromatography (LC). In one embodiment, the liquid chromatography is high-performance liquid chromatography (HPLC), in serial or multiple parallel HPLC columns. In another embodiment, the chromatographic technique is gas chromatography (GC).

In one embodiment, following fast separation of the components of library compound sample, the products of the biological reaction are detected by a detector to determine the presence or absence of a reaction and if applicable, the products of the reaction in a biomolecular screen functional assay. In one embodiment, the detection is performed by mass spectrometry (MS). In another embodiment, the time-efficient fast separation is liquid chromatography followed by mass spectrometric detection (LC/MS). In another embodiment, the mass spectrometry is performed by multiplexed elution into the mass spectrometer (MUX-LC/MS). The fast LC separations of the invention are achieved through temperature tuning the separation to minimize peak width.

In one embodiment, the methods of the invention are applied to the high throughput screening for any therapeutic targets, for example without limitation, to treat diseases or conditions in the neurological, infectious disease, diabetes, and obesity indications.

In one embodiment, the methods of the invention following fast separation (LC) of the biological activity reaction components use a detection system including, for example without limitation, mass spectrometry (MS), high resolution mass spectrometry (HRMS), tandem mass spectrometry (MS/MS), fluorescent detection, and radioactive detection.

In one embodiment, the methods of the invention include fast separation (LC) followed by detection by mass spectrometry (MS) methods for biomolecular screening that allow for screening enzyme targets where current conventional HTS tools fail to work. In one embodiment of the invention, more than one chromatography/detection system is operated in parallel to achieve higher throughput.

In one embodiment, the fast separation and detection HTS methods of the invention are used to quickly advance validated targets in HTS screening from the validation phase into and through lead optimization phases. In one embodiment, the methods of the invention are applied to develop bioassays and provide HTS and secondary screening by GC/MS or LC/MS.

In another aspect of the invention, the methods of ultra-fast or time-efficient separations can be used to implement new high speed separation/MS technology to perform MS based biomolecular screens in the context of HTS time scales.

### BRIEF DESCRIPTION OF THE DRAWINGS

FIG. 1 is a schematic of the process steps of the invention.

FIG. 2 is a schematic of the precision of the detection methods of the invention showing a distinct signal for neurological therapeutic target screening the upper line representing the steroid substrate conversion with no inhibition and the bottom line with complete inhibition present for oxidation demonstrating an easily detectable signal to noise ratio with a confidence interval of Z′=0.71.

FIG. 3 is a schematic representation of one of the optimization curves for the liquid chromatographic conditions used in the time-efficient high throughput screening methods of the invention.

FIG. 4 is a schematic of the synthetic pathway of ALLO by 3α-HSD.

FIG. 5 shows the GC/MS plots of a negative and positive inhibitors in a plot of a 2 minute GC/MS fast separation method of the invention.

FIG. 6 shows the bacterial inhibitory IC₅₀ of a compound found by the methods of the invention.

FIG. 7 shows a plot of the typical LC/MS analysis profile of the substrate CoA(top), substrate product acetyl-CoA(middle), and internal standard detection (bottom).

FIG. 8 shows a schematic of the mitochondrial CPT system outer membrane bound CPT-I and CPT-II.

FIG. 9 shows a typical LC/MS analysis profile of the method of the invention to detect compounds that activate a diabetes obesity target, fatty acid-carnitine(bottom) with a distinction coefficient of Z′ of 0.84 when compared to internal standard(top).

FIG. 10 shows a plot of two cycles of a 4-way parallel (MUX) LC/MS run of 21 seconds per LC/MS sample per MS instrument, a total of 168 seconds for 8 LC/MS samples.

FIGS. 11A, 11B and 11C show plots of LC/MS screens of the invention for (A) glycerides; (B) CoA's, and (C) pyrophosphates.

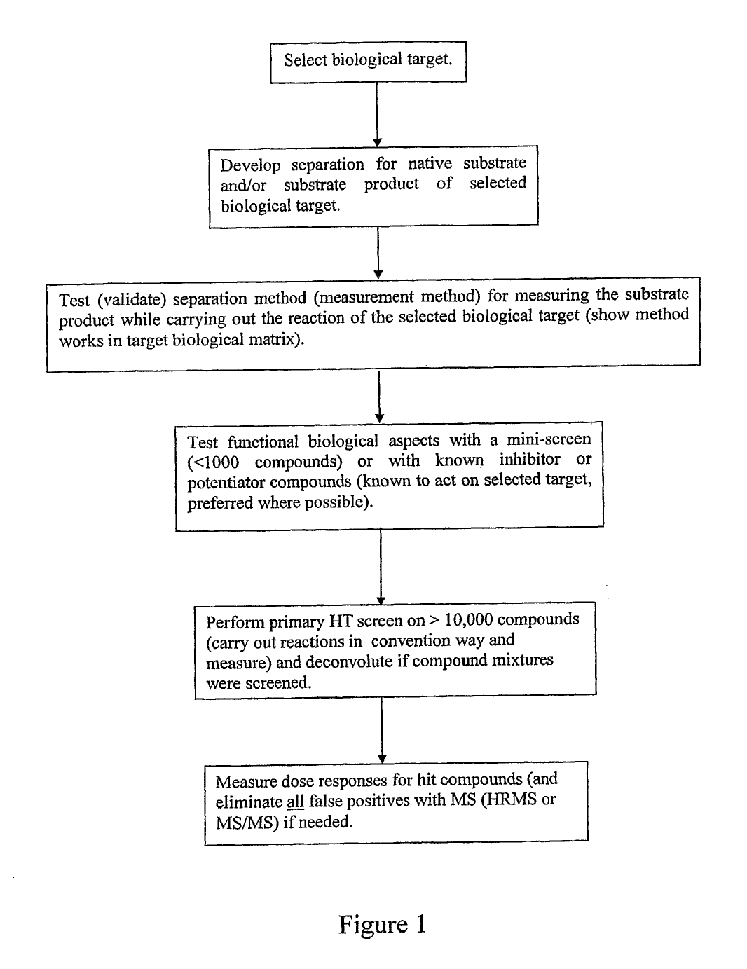

### DETAILED DESCRIPTION OF THE INVENTION

The following are definitions of terms used in describing this invention:

“High throughput screening (HTS)” is defined as screening of greater than 1,000 different samples of medicinal compound drug candidates or wells containing these different drug candidates per therapeutic target, excluding controls, for the purpose of evaluating efficacy against the therapeutic target or targets.

“Functional assay” is defined as high throughput screening of greater than 1,000 medicinal compound drug candidates per therapeutic target or targets, for the purpose of evaluating activity or efficacy of the drug candidates against the target or targets, where the biological reaction is carried out and a substrate, substrate product, or products are measured.

“Fast” or “ultra-fast separation” is defined as a separation of components having a retention time tᵣ less than or equal to three minutes, and having a variance C (peak width at 0.6065×full peak height=2σ) or distribution width of less than or equal to 5 seconds.

Unless otherwise defined, all technical and scientific terms used herein have t meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety as if each had been specifically incorporated herein by reference. In case of conflict, the present specification, including definitions, will control.

Previous methods of high throughput screening have described the use of mass spectrometry for detection but not using a separation. BioTrove, Inc., for example as described in the '629 patent cited above, uses mass spectrometry for detection of activity assay results. However, the '629 patent describes flow injection of the samples after washing the sample off a conveyor belt or tape. The BioTrove method described in the '629 patent sacrifices chemical specificity and quantitative accuracy in order to gain speed. This in turn leads to a high rate of false positives caused by the interference and cross-contamination by compound library candidates being screened, or not detecting the change in substrate product concentration when it occurs due to the low precision and accuracy of the BioTrove system though it uses MS detection.

In addition, many methods of high throughput screening applied to bioassays of compound libraries require non-native substrates for detection, for example fluorescence labels, which can yield results that are not biologically relevant. Other detection methods for example, radioactive labels, pose high safety and disposal costs and still require separating the substrate from the substrate product in the presence of the library compound or drug candidate compounds being screened. In addition, traditional assay development is very time consuming and cannot anticipate or adapt to the challenges/interferences encountered from the drug candidate compounds. The frequent results are missed hits and a large number of false positives, often greater than ten fold the number of leads. Furthermore, optical readouts for HTS plates often do not have sufficient molecular specificity, precision, or dynamic range to distinguish hits from noise, particularly in activation assays. The methods of the present invention overcome these and other problems not addressed by current HTS methodologies by directly separating and measuring the substrate product(s) in a functional biological reaction.

Among the advantages of the methods of the present invention are the implementation of fast separations in an HTS-meaningful time scale at the front end of the screening process, and the use of accepted practice reaction conditions for biological reactions resulting in accurate results prior to the detection phase of screening. The benefits of the methods of the present invention are manifold including but not limited to, (a) allowing the screening of targets not previously screenable by HTS, (b) reduction or even elimination of false positives depending on the detector chosen, and (c) a high level of accuracy and precision allowing small differences to be observed and thus better prioritization of compound efficiencies.

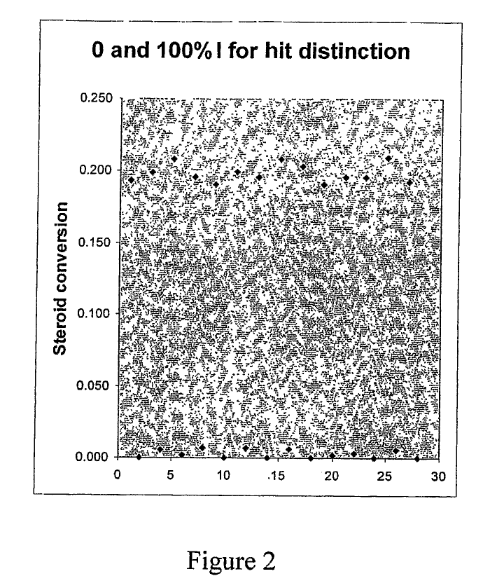

The time-efficient or fast separation methods of the invention combined with specific and sensitive detection systems, for example, mass spectrometry (MS), overcome many of the limitations of current HTS methods, given that MS is adaptable to most molecules and provides distinction based on molecular weight allowing intact native substrate and substrate products to be measured. Firstly, fast separations prevent interference of the substrate with the substrate product even in the presence of drug candidate compounds. Secondly, assay development time is significantly decreased using separations coupled with MS by about 5 fold, which overcomes any modest increases in measuring time. The use of MS/MS or high resolution mass spectrometry (HRMS) can be easily incorporated into the assay to anticipate or adapt to the challenges/interferences encountered from the drug candidate compounds. Lastly, separations using chromatographic techniques of the invention coupled with MS detection often have enough excess precision, approximately 5% RSD, and dynamic range of approximately 3 orders of magnitude to easily distinguish hits from noise, even in difficult activation assays (see FIG. 2). The methods of the invention allow for fast, time-efficient chromatographic separations of compounds using an optimum separation technique having retention times of under 3 minutes, and σ (variance) or peak width distributions of less than 5 seconds. The fast chromatographic methods of the invention can be coupled with a variety of detection methods known in the art, including without limitation mass spectrometry (MS), high resolution mass spectrometry (HRMS), tandem mass spectrometry (MS/MS), fluorescent detection, and radioactive detection. As the examples below show, a successful candidate to lead screen can be performed in a fraction of the time as currently used high throughput screens.

The methods of the invention include a method of drug lead high throughput screening for biological activity of a substrate from among a compound library comprising: a) developing a method to measure biological activity against a standard for the substrate, b) optimizing chromatographic separation of the substrate compound for speed using a mass spectrometry detection system for monitoring and measuring the reaction component concentrations to define an optimum separation, c) optimizing detection measurement of the concentration of the substrate compound to define an optimum measurement to define an optimum measurement, d) optimizing detection measurement of the biological reaction to determine the activity of the compound to define an optimum measurement, e) processing in excess of 1,000, and preferably in excess of 10,000, compound library samples through reaction and incubation steps, f) processing the compound library sample reactions through chromatographic separation phase according to the defined optimum separation, g) processing the post-reaction and incubation chromatography eluents through mass spectrometry detection to determine the most active compounds as drug leads according to the defined optimum separation and detection, and h) processing the drug leads through cell-based assays. The methods of the invention allow for processing well in excess of 10,000 samples for high throughput screening of compounds, in a significant time-saving scale over methods previously known in the art.

In a preferred embodiment, the process of the invention is optimized to be time efficient in a high throughput screening application such that in excess of 1,000 samples, and preferably in excess of 10,000, samples or wells per target or single project with different compounds in each well (excluding controls) are screened for the purpose of evaluating efficacy against a desired target or targets for therapeutic development. In another preferred embodiment of the invention, in excess of 10,000 compounds per target or single project are screened for the purpose of evaluating efficacy against a target or targets, where substrate products or related products are measured in a functional assay. In another preferred embodiment of the invention, the chromatographic separations are performed in an ultra-fast time scale, where retention time t^{r} is less than or equal to three minutes, and having a σ (variance), or distribution width of less than or equal to 5 seconds.

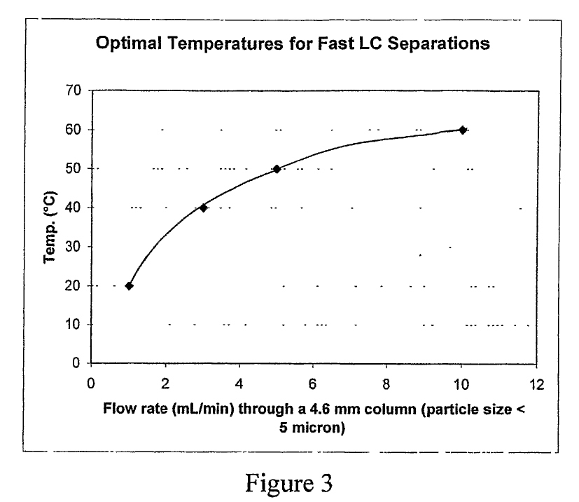

In a preferred embodiment, the chromatographic separation of the invention is performed by liquid chromatography optimized to fast parameters. In another preferred embodiment, the chromatographic separation is performed by gas chromatography optimized to fast parameters. Liquid chromatographic separation of the method of the invention can be optimized by optimizing, without limitation: the flow rate through the chromatographic column to increase speed through the column; increasing the back-pressure through the column; optimizing Van Deemter curves, and optimizing temperature versus velocity through the column, as shown in FIG. 3. These parameters can be further optimized for the type of stationary phase of the liquid chromatography column. For example when using silica-based stationary phase the temperature is optimized not to exceed 100° C. but can be greater than 60° C. when using a graphite or Zirconia stationary phase.

In a more preferred embodiment of the invention, the chromatographic separation is performed by liquid chromatography, including without limitation column LC, high pressure liquid chromatography (HPLC), multiple parallel HPLC, serial multiplex-HPLC, and supre-critical fluid chromatography and the detection of the biological reaction is performed by mass spectrometry (LC/MS). Other more preferred embodiments of the methods of the invention include liquid chromatography separation as described above and at least one detection system including, without limitation mass spectrometry (MS), ultraviolet (UV) detection, fluorescence detection, flame ionization detection, evaporative light scattering detection (ELSD), and radioactive detection. In another preferred embodiment of the invention the chromatographic separation is gas chromatography, and the detection method includes, without limitation, mass spectrometry (MS), electron capture detection, nitrogen detection, flame ionization detection, and evaporative light scattering detection (ELSD) for non-specific quantitative detection. The methods of the invention also include multiple parallel and serial injections onto an LC column performing a separation of the invention, “staggering” injections allowing for multiple resolution of peaks within a reduced time period when compared to the time it would take to fully elute an injected sample before injecting the next sample for resolution on the LC column. The methods of the invention further include any of the various combinations of fast chromatographic and detection methods herein described and known in the art within the parameters of HTS and fast separations described herein.

In a preferred embodiment of the invention, more than one system using at least one of the chromatography modalities of the invention in combination with any of the detection modalities of the invention is used in parallel to achieve higher throughput. In one embodiment of the invention, more than one chromatography/detection system run in parallel to achieve higher throughput includes for example, without limitation, multiple HPLC/MS, HPLC/MS/MS, HPLC/HRMS, and HPLC/Radioactivity Detection. In one embodiment, the number of multiple chromatography/detection systems run in parallel are two, ten, or 100 or more systems to achieve significantly increased throughput.

In a more preferred embodiment of the invention, the detection system is gas chromatography GC. In a more preferred embodiment of the invention, the GC detection is optimized to maintain optimal peak width by ensuring zero dead volume in the GC unit.

The methods of the invention can be applied to screening drug leads to diverse and various biological therapeutic targets, including without limitation, neurological targets, infectious disease targets, diabetes targets, and other biomolecular screening.

### Neuroscience Target High Throughput Screens

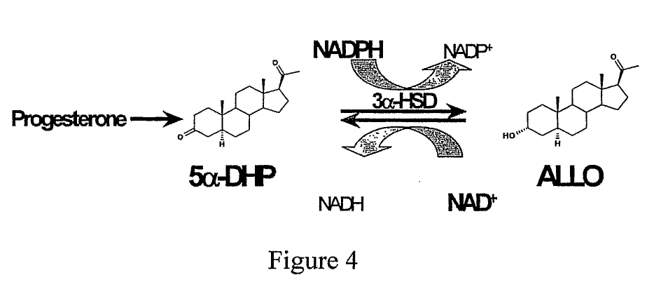

The methods of the invention can be applied to neuroscience therapeutic targets that have proven difficult for known high throughput screening methods. One such target is 3α-HSD, a type 3 hydroxy steroid dehydrogenase which synthesizes allopregnanolone (ALLO) a neuroactive neurosteroid, which is synthesized independently of peripheral steroidogenesis. The synthetic pathway of ALLO by 3α-HSD is shown in FIG. 4. ALLO is the most potent endogenous positive allosteric modulator of GABA_{A} receptor function. In low nanomolar concentrations, ALLO potentiates GABA induced chloride channel conductance. ALLO is a potent anxiolytic, anticonvulsant and sedative/hypnotic agent. The clinical manifestations of ALLO in various disease states, principally clinical depression, include a significant decrease of ALLO in cerebrospinal fluid (CSF) and in plasma in patients with depression and PMDD; levels of ALLO in CSF positively correlate with antidepressant effect of serum serotonin re-uptake inhibitors (SSRIs); CSF levels of ALLO negatively correlate with depressive symptom severity. The biochemical relevance of ALLO in clinical depression are the effect of SSRIs which increase ALLO in human CSF and plasma, and in the rat brain; and the dramatic effect by SSRI's on ALLO biosynthesis and degradation. Animal models indicate that ALLO has an anti-depressant like effect in the forced swim test in mice. Social isolation in mice and rats decreases ALLO brain content. Fluoxetine reverses the social isolation-induced decrease in cortical ALLO levels in mice. However, the present state of art of high throughput screens using chromaphore labeled substrates do not correlate with known 3α-HSD behavior, so a conventional functional assay has not been developed. Radiolabeling of substrates requires a separation and have proven expensive, have increased handling and safety risks. The current detection systems using thin layer chromatography (TLC) radiolabel or liquid chromatography have proven unusable in the contrast, the methods of the present invention using GC/MS HTS methodologies, provided several advantages, including: specific detection of substrate and substrate products in a functional assay; the functional assay works in both the oxidation and reduction directions allowing selectivity or reuptake screening.

A screen of bioactive compounds against 3α-HSD type 3, hydroxy steroid dehydrogenase, using the methods of the present invention (using 2 GC/MS screens) resulted in 216 potent oxidation inhibitor candidate compounds found by GC/MS methods of the invention from over 300,000 medicinal chemistry library compounds screened. Of these compounds 51 have greater than 10 fold selectivity toward oxidation inhibition. All 51 were GC/MS hits, with the best compound being 41 fold selective having an IC₅₀(ox)=3 nM, and which is amenable to being developed into a therapeutic compound. The time advantage of the methods of the invention is apparent in that it took only one year from method development (4 months) to screen (8 months) to transition from candidate to lead stages of therapeutic development. Using fast GC/MS, more than 50 hit compounds were found with high selectivity against reuptake. For 2 of the hits, x-ray crystal structures were obtained with the compounds being present in the 3α-HSD active site. This x-ray crystal structure provides a completely independent validation of the method of the invention using GC/MS assay modalities.

One of the most important results of using the methods of the invention are the lack of false positives so meaningful structural motifs and structure/function correlations can be made. Thus the methods of the invention are successful to advance high throughput screen from library compound candidates to therapeutic lead stage in a shorter time period than the known high throughput methods known in the art in neurological target screens.

### Infectious Disease Target Screens

The methods of the invention can be applied to infectious disease therapeutic targets that have proven difficult for known HTS methods. The need for novel anti-infective compounds is highlighted by rising resistance incidences for currently used anti-infective compounds. In many instances, the broad spectrum antimicrobial therapeutics believed to be the last line of defense against bacterial pathogens are the current standard of treatment for many infectious diseases creating a potential for a lack of antimicrobial compounds should resistance to these therapeutics arise. Membrane bound proteins are important anti-infective targets due to their specificity. Among the targeted bacterial functions are cell wall synthesis due to the different biochemistry in bacteria and animal cells that lack a cell wall. One particular target, where there is no homologous protein in humans or animals is a bacterial membrane bound transport regulatory protein or mbTRP. Inhibition of mbTRP, and was the target of selection of an infectious disease high throughput screen using the methods of the invention. The targeted mbTRP is a bifunctional enzyme essential for bacterial cell-wall synthesis that is highly conserved in both Gram (+) and Gram (−) organisms. There is no homologous protein in humans or animals therefore mbTRP is a specific target and is a completely novel target that has been validated both in vivo and in vitro. However, the current methods of high throughput screening have several problems to implement an mbTRP inhibitor screen. First is the cost of the enzyme, which requires a 20 fold excess for calorimetric detection, the colored compounds being screened interfere with the calorimetric detection, the enzyme is not stable without dithiothreitol (DTT), or other anti-oxidant, which cross reacts with Ellman's reagent 5,5-dithio-bis [2-nitrobenzoic acid] (DTNB), causes high background, and the measurements are non-specific because any sulfhydryl group reacts with DTNB. The methods of the present invention allow for a direct measurement of intensity vs. time for the molecular ions of the Ac-CoA substrate and CoA substrate product. A fast gradient LC was used to isolate products from all interferences including from DTT. The methods of the present invention provide sufficient sensitivity to monitor Ac-CoA and CoA at biologically relevant concentrations.

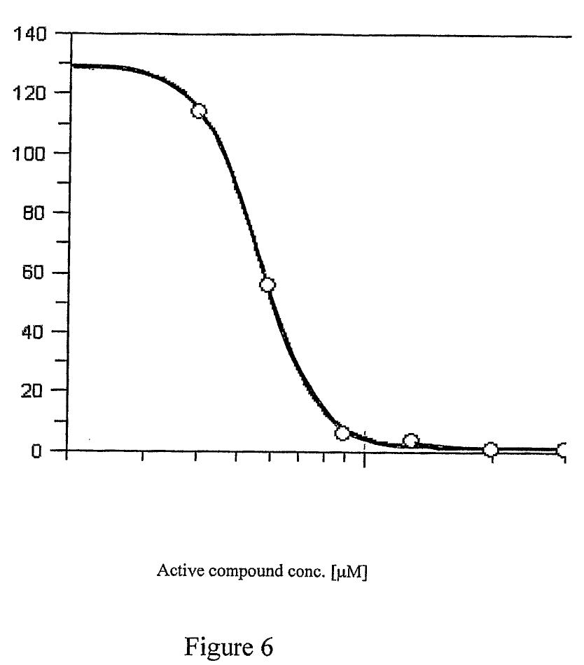

A functional biomolecular screen to was used to screen to find lead compounds that inhibit mbTRP. The IC₅₀ is measured for hits in selection of compounds for lead optimization and to provide potency measurements (IC₅₀) of optimized leads. The LC/MS modalities of the methods of the present invention were used to perform a primary screen and kinetic IC₅₀ measurements were performed on hits and optimized leads. Of over 105,000 medicinal library compounds screened (20×), 77 hits were found, 43 were validated in cell assays, and 6 compounds were selected as leads and moved from the candidate phase to the lead optimization phase. FIG. 6 shows the IC₅₀ profile of a lead compound identified by the methods of the invention showing highly precise and reproducible results and the sensitivity of the assay being able to detect small differences in potency even without an internal standard. This compound resulted in a transition of the target into the lead optimization phase.

### Obesity and Diabetes Target Screens

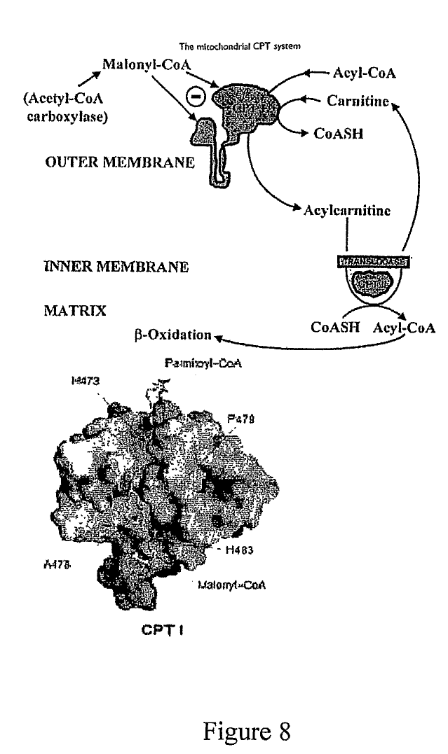

The methods of the invention can be applied to diabetes/obesity therapeutic targets that have proven difficult for known HTS methods. It has recently been shown that acetyl Co-A carboxylase 2 (ACC2)−/− mice had 10 to 30 fold lower malonyl-CoA concentration in heart and muscle respectively (Science 2001; 291: 2613). This results in a 30% higher rate in fatty acid oxidation in the soleus muscle and a 20% lowering of serum glucose. Malonyl-CoA is a potent inhibitor of M CPT-I (69 nM). Therefore, the lower malonyl-CoA concentration in muscle cells without ACC2 led to an increase of M-CPT-I activity, which is the rate limiting step in beta oxidation (the essential step for fatty acid excretion). Over-expression of L-CPT-I increases insulin sensitivity in muscle cells and counteracts fatty acid induced insulin resistance (Brown et al. 2003 ADA Poster 36LB). Compounds blocking the malonyl-CoA inhibition of M-CPT-I should cause metabolic effects similar to those seen in ACC2−/− mice. FIG. 8 shows a schematic of the mitochondrial CPT system outer membrane bound CPT-I and CPT-II (McGarry et al. 2001, and Morillas et al. (2002) JBC 277(13):11473). The biological activity used for the assay is the conversion by CPT-1 of palmitoyl-CoA (fatty acid-CoA) and carnitine to palmitoyl carnitine complex and free CoA. In this reaction optical detection is not possible due to the high background so the malonyl-CoA effect is not observable. Previous unsuccessful attempts have been made in the high throughput screens biological functional assays known in the art. One is DTNB derivatization and cc-ketoglutarate derivatization with α-ketoglutarate dehydrogenase. Although radiolabeled detection has been used with limited success, it still requires large scale manual separation using liquid-liquid extraction that cannot be readily automated. The methods of the present invention obviate these problems by allowing fast on-line separation by using a gradient liquid chromatography to isolate substrate products from interferences and allowing direct measurement of intensity vs. time for the molecular ions of palmitoyl-carnitine, the substrate product without derivatization. These measurements were conducted in ultra-fast chromatography separation scale of 0.75 seconds at nanomolar sensitivity, with good quantitative precision without internal standards.

### Other CoA Substrate Target Screens

The methods of the invention can be also applied to a variety of targets that have proven difficult for known high throughput screening methods due to their lack of specificity and high rate of false positives. One important application of the methods of the present invention allow conjugates are involve in energy regulation, and so are ubiquitous and important therapeutic targets. Previously, in order to measure Co-A's, they had to be conjugated to an easily detectable moiety, however, these proved difficult and fraught with artifacts and inefficiencies. In their natural state, CoA's are complexed to sugars, fatty acids, and other molecules.

The methods of the invention are used to screen for CoA targets, including without limitation, Coenzyme A (CoA, CoASH, HSCoA), Acetyl-CoA, Arachidonyl Coenzyme A, Butyryl Coenzyme A, Crotonyl Coenzyme A, Decanoyl coenzyme A, Docosanoyl Coenzyme A, Eicosatrienoyl 8,11,14 Coenzyme A, Heptadecanoyl Coenzyme A, Hexacosanoyl Coenzyme A, Hexanoyl Coenzyme A, Hydroxy butyryl Coenzyme A, Hydroxy-3-methylglutaryl Coenzyme A, Isobutyryl Coenzyme A, Lauroyl Coenzyme A, Lignoceryl Coenzyme A, Linoleoyl Coenzyme A, Malonyl Coenzyme A, Methylmalonyl Coenzyme A, Myristoyl Coenzyme A, Nonadecanoyl Coenzyme A, Octanoyl Coenzyme A, Oleoyl Coenzyme A, Palmitoyl Coenzyme A, Propionyl Coenzyme A, Stearoyl Coenzyme A, and Succinyl-CoA.

### Obesity, Diabetes, Cardiovascular and Other Target Screens

The methods of the invention are applied to the high throughput screening for other therapeutic targets for example those involving di- and triglycerides, substituted CoA's and alkyno pyrophosphates, for example dioleyl glycerol acyl transferase (DGAT, acetyl CoA carboxylase (ACC2), and farnesyl pyrophosphate synthase (FPPS) target.

The methods of the invention include fast separation (LC) followed by detection (MS) methods for biomolecular screening that allow for screening enzyme targets where current conventional HTS tools fail to work. Additional specific and detailed applications of the methods of the invention are illustrated by the examples below.

The present invention having been described in the foregoing detailed description, the following examples are to be interpreted as illustrative of the various aspects of the invention and are not to be limiting of the bounds of the invention as delineated by the claims that follow.

### EXAMPLES

### Example 1

### Neurological Target High Throughput Screen: 3α-HSD

GC/MS HTS—A screen of bioactive compounds against 3α-HSD type 3, hydroxy steroid dehydrogenase, using the methods of the present invention (using 2 GC/MS screens) resulted in 216 potent oxidation inhibitor candidate compounds found by GC/MS methods of the invention from over 300,000 medicinal chemistry library compounds screened. Of these compounds 51 have greater than 10 fold selectivity toward oxidation inhibition. All 51 were GC/MS hits, with the best compound being 41 fold selective having an IC₅₀(ox)=3 nM, and which is amenable to being developed into a therapeutic compound. The time advantage of the methods of the invention is apparent in that it took only one year from method development (4 months) to screen (8 months) to transition from candidate to lead stages of therapeutic development. Of the 51 compounds 12 are parallel synthesis compounds, 2 of these were re-synthesized in large scale and x-ray crystal structures were obtained in the 3α-HSD active site. This x-ray crystal structure provides a completely independent validation of the method of the invention using GC/MS assay modalities.

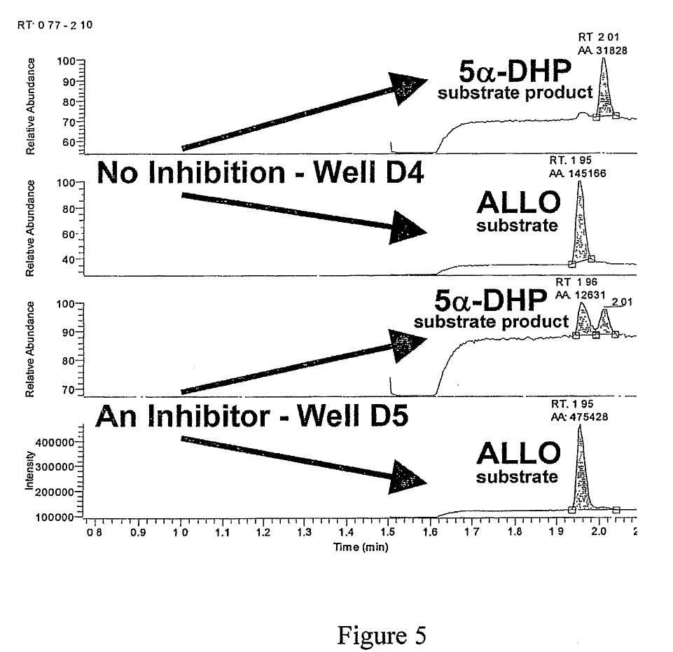

FIG. 5(A) shows the chemical structures of phenyl and imidazole inhibitors of 3α-HSD, and FIG. 5(B) shows the GC/MS plots of a negative and positive inhibitors in a plot of a 2 minute GC/MS ultra-fast separation method of the invention.

### Example 2

### Infectious Disease Target High Throughput Screen

LC/MS HTS—Inhibition of mbTRP was the target of selection of an infectious disease high throughput screen using the methods of the invention. A functional biomolecular screen to mbTRP was used to screen to find lead compounds that inhibit mbTRP. The IC₅₀ is measured for hits in selection of compounds for lead optimization and to provide potency measurements (IC₅₀) of optimized leads. The LC/MS modalities of the methods of the present invention were used.

A functional biomolecular screen to mbTRP was used to screen to find lead compounds that inhibit mbTRP. The IC₅₀ is measured for hits in selection of compounds for lead optimization and to provide potency measurements (IC₅₀) of optimized leads.

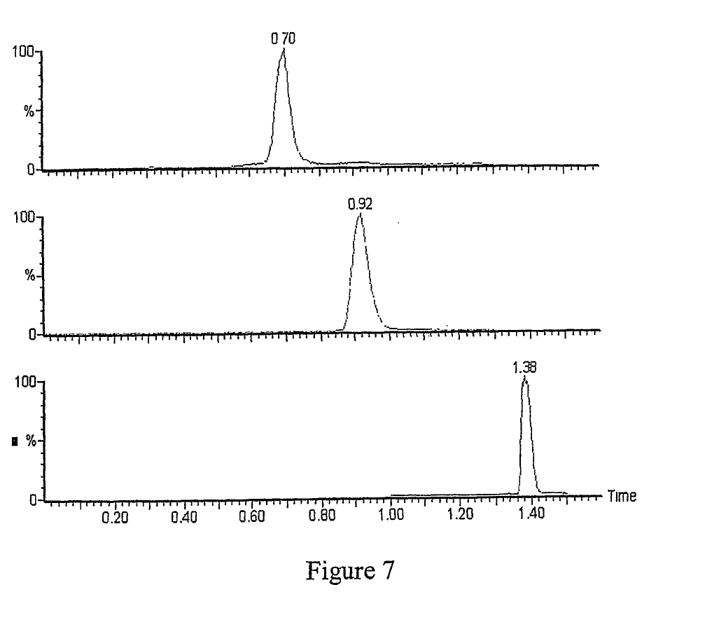

The LC/MS modalities of the methods of the present invention were used to perform a primary screen and kinetic IC₅₀ measurements were performed on hits and optimized leads. Of over 105,000 medicinal library compounds screened (20×), 77 hits were found, 43 were validated in cell assays, and 6 compounds were selected as leads and moved from the candidate phase to the lead optimization phase. FIG. 6 shows the typical IC₅₀ of the anti-microbal compounds identified by the methods of the invention showing highly reproducible and precise data, and the sensitivity of the detection method able to detect even small differences in potency observable even without an internal standard. FIG. 7 shows the a plot of the typical LC/MS analysis profile of the substrate, substrate product and internal standard detection.

### Example 3

### Diabetes Target High Throughput Screen: CPT1

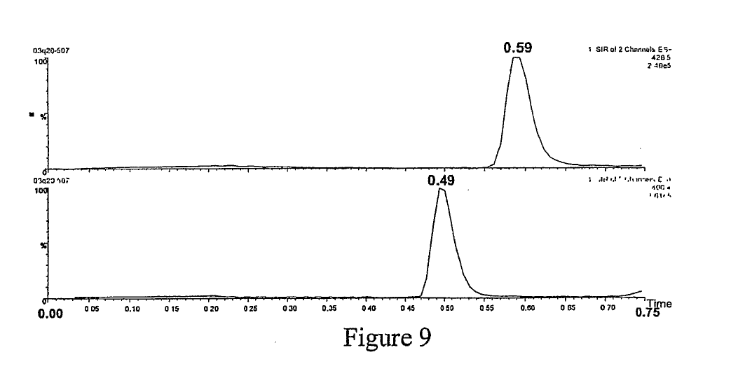

LC/MS HTS—It has recently been shown that acetyl Co-A carboxylase 2 (ACC2)−/− mice had 10 to 30 fold lower malonyl-CoA concentration in heart and muscle respectively (Science 2001; 291:2613). This results in a 30% higher rate in fatty acid oxidation in the soleus muscle and a 20% lowering of serum glucose. Malonyl-CoA is a potent inhibitor of M CPT-I (69 nM). Therefore, the lower malonyl-CoA concentration in muscle cells without ACC2 led to an increase of M-CPT-I activity, which is the rate limiting step in beta oxidation (the essential step for fatty acid excretion). Over-expression of L-CPT-I increases insulin sensitivity in muscle cells and counteracts fatty acid induced insulin resistance (Brown et al. 2003 ADA Poster 36LB). Compounds blocking the malonyl-CoA inhibition of M-CPT-I should cause metabolic effects similar to those seen in ACC2−/− mice. FIG. 8 shows a schematic of the mitochondrial CPT system outer membrane bound CPT-I and CPT-II (McGarry et al. 2001, and Morillas et al. (2002) JBC 277(13):11473). The biological activity used for the assay is the conversion by CPT-1 of palmitoyl-CoA and carnitine to palmitoyl carnitine complex and free CoA. In this reaction optical detection is not possible due to the high background so the malonyl-CoA effect is not observable. Two unsuccessful attempts have been made in the high throughput screens biological functional assays known in the art. The first is DTNB derivatization and α-ketoglutarate derivatization with α-ketoglutarate dehydrogenase. Although radiolabeled detection has been used with limited success, it still requires large scale manual separation using liquid-liquid extraction that cannot be readily automated. The methods of the present invention obviate these problems by allowing fast on-line separation by using a gradient liquid chromatography to isolate substrate products from interferences and allowing direct measurement of intensity vs. time for the molecular ions of palmitoyl-carnitine, the substrate product without derivatization. These measurements were conducted in ultra-fast chromatography separation scale of 0.75 seconds at nanomolar sensitivity, with good quantitative precision without internal standards. FIG. 9A shows a typical LC/MS analysis profile of the method of the invention to detect compounds that block the malonyl-CoA inhibition of M-CPT-1 inhibition with a confidence interval Z′ of 0.84 (+/−mal-CoA) showing distinct retention times for internal standard stearoyl-carnitine and substrate product palmityl-carnitine. FIG. 9B shows the malonyl-CoA inhibition of human MCPT-I measured by the LC/MS HTS methods of the invention showing an IC₅₀=41 nM which is corroborated independently by the literature.

### Example 4

### CoA Substrate Target High Throughput Screen

LC/MS HTS—CoA conjugates are involve in energy regulation, and so are ubiquitous and important therapeutic targets. Previously, in order to measure Co-A's, they had to be conjugated to an easily detectable moiety, however, these proved difficult and fraught with artifacts and inefficiencies. In their natural state, CoA's are complexed to sugars, and fatty acids.

The methods of the invention are used to screen for CoA targets, including without limitation, Coenzyme A (CoA, CoASH, HSCoA), Acetyl-CoA, Arachidonyl Coenzyme A, Butyryl Coenzyme A, Crotonyl Coenzyme A, Decanoyl coenzyme A, Docosanoyl Coenzyme A, Eicosatrienoyl 8,11,14 Coenzyme A, Heptadecanoyl Coenzyme A, Hexacosanoyl Coenzyme A, Hexanoyl Coenzyme A, Hydroxy butyryl Coenzyme A, Hydroxy-3-methylglutaryl Coenzyme A, Isobutyryl Coenzyme A, Lauroyl Coenzyme A, Lignoceryl Coenzyme A, Linoleoyl Coenzyme A, Malonyl Coenzyme A, Methylmalonyl Coenzyme A, Myristoyl Coenzyme A, Nonadecanoyl Coenzyme A, Octanoyl Coenzyme A, Oleoyl Coenzyme A, Palmitoyl Coenzyme A, Propionyl Coenzyme A, Stearoyl Coenzyme A, and Succinyl-CoA.

### Example 5

### Other Target High Throughput Screens

LC/MS HTS—A target of interest for obesity and diabetes novel therapeutic compound screening is dioleyl glycerol acyl-transferase (DGAT). This target has solid validation for obesity and diabetes indications and is a high priority target for many pharmaceutical companies. The assay of the invention has a linear dynamic range of detection of 100 nM to 50 μM where previous screens using radiolabel and scintillation proximity assay (SPA) yielded no confirmable results.

Another target of interest for novel diabetes and obesity therapeutic screen is acetyl Co-A carboxylase (ACC2). ACC2 converts acetyl CoA to malonyl Co-A. This target has also been solidly validated as an obesity and dilates therapeutic target and is also a high priority target. The LC/MS modalities of the invention has a dynamic range of 50 nm to 50 μM dynamic range.

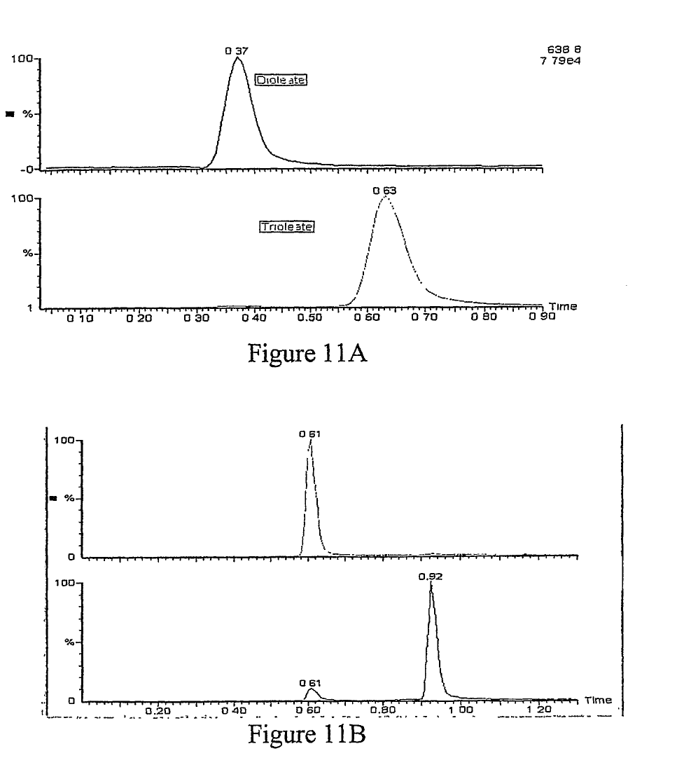

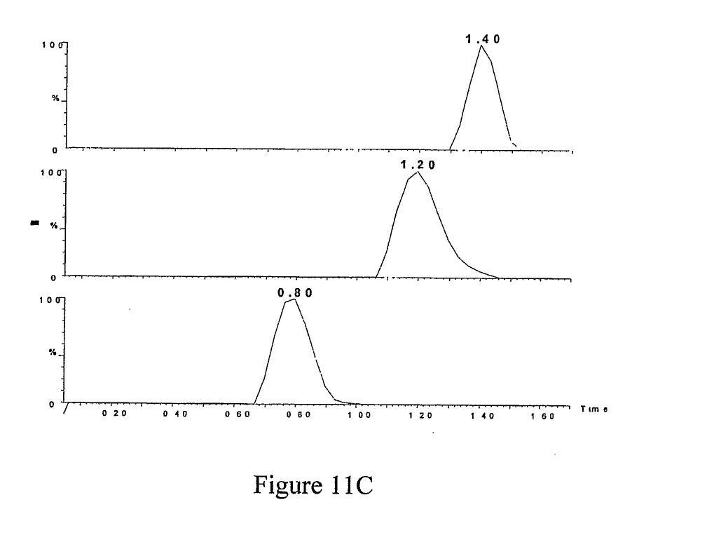

Yet another target for novel diabetes and obesity therapeutics is farnesyl pyro phosphate synthase (FPPS). with comparable LC/MS assay dynamic range as the other diabetes and obesity LC/MS screens. FIG. 11 shows plots of LC/MS screens of the invention for (A) DGAT; (B) ACC2, and (C) FPPS therapeutic targets.

### Example 6

### Multiplex High Throughput Screen

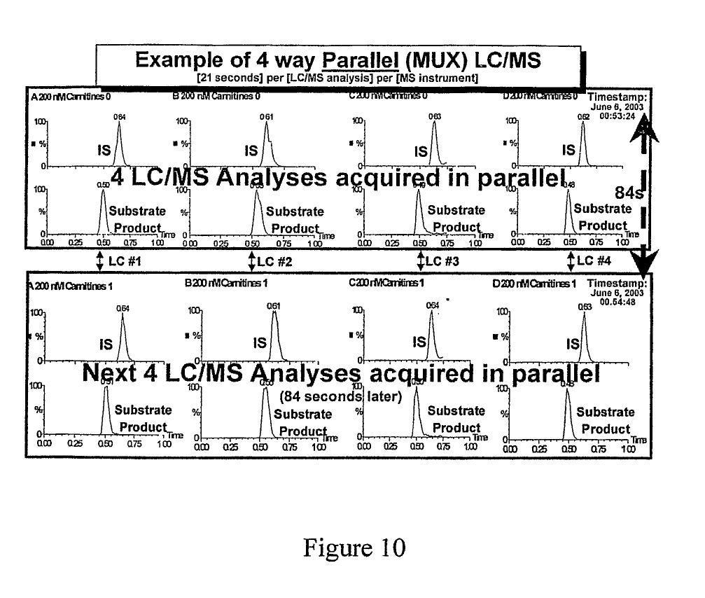

MUX-LC/MS HTS—By using a multiplexing (MUX) or four-way parallel autosampler instead of four sequential autosamplers a slightly better than four-fold increase in speed can be gained using the LC/MS modalities of the methods of the invention. Two four-way MUX-LC/MS systems reduce LC/MS measurement time. One advantage of using a multiplexed 4-way autosampler is cost saving of about 50% over 4 equivalent sequential LC/MS measurements. FIG. 10 shows a plot of 4-way parallel (MUX) LC/MS run of 21 seconds per LC/MS sample per MS instrument, 84 s cycle for 4 way MUX LC/MS (84 second per 4 way assay=21 s per each analysis). Thus the cycle time for this 4 way parallel assay is 84 s, which is the same time it takes in a single LC/MS run, thus the method of the invention results in a four fold speed improvement.

The present invention having been described in the detailed description above and illustrated by the non-limiting examples, the foregoing description and illustrative and non-limiting examples are to be interpreted as illustrative of the various aspects of the invention and are not to be limiting of the bounds of the invention which is defined by the scope of the following claims. Other aspects, advantages, and modifications are within the scope of these following claims.

1. A method of drug candidate high throughput functional biomolecular screening for biological activity of a substrate from a compound library, said method comprising the steps of:
a) developing a method to measure substrate product formation for a biological reaction of a substrate, said biological reaction catalyzed by a target protein;
b) optimizing chromatographic separation of said substrate and said substrate product for speed by detecting substrate and/or substrate product concentrations;
c) optimizing measurement of the concentration of said substrate and/or said substrate product in a functional assay with said target protein;
d) providing in excess of 1,000 compounds in a compound library, and processing each of said compounds with said substrate and said target protein in said functional assay to produce reaction products;
e) processing said reaction products through chromatographic separation according to the separation of step (b), resulting in eluents;
f) processing said eluents through mass spectrometry detection using the measurement of step (c); and,
g) selecting at least one compound as a drug candidate wherein said at least one compound exhibits a high level of inhibition, modulation, or potentiation of said biological reaction relative to the level of inhibition, modulation, or potentiation exhibited by other compounds.

2. The method of claim 1 wherein the chromatographic separation is liquid chromatography.

3. The method of claim 1 wherein the chromatographic separation is gas chromatography.

4. The method of claim 1 wherein the detecting is performed by a detection system selected from the group consisting of mass spectrometry (MS), tandem mass spectrometry (MS/MS), high resolution mass spectrometry (HRMS), radioactive detection, and fluorescent detection.

5. The method of claim 1 wherein in excess of 10,000 samples are processed.

6. The method of claim 1 wherein the chromatographic separation has retention times of assayed compounds of 3 minutes or less, peak variance or dispersion σ equal to half peak width of 0.6065×full peak height and peak width resolution less than or equal to 5 seconds.

7. (canceled)

8. The method of claim 6 wherein the substrate or substrate product for target screened for activity is CoA or a CoA-conjugate.

9. The method of claim 8 wherein the CoA conjugate is selected from the group consisting of Coenzyme A (CoA, CoASH, HSCoA), Acetyl-CoA, Arachidonyl Coenzyme A, Butyryl Coenzyme A, Crotonyl Coenzyme A, Decanoyl coenzyme A, Docosanoyl Coenzyme A, Eicosatrienoyl 8,11,14 Coenzyme A, Heptadecanoyl Coenzyme A, Hexacosanoyl Coenzyme A, Hexanoyl Coenzyme A, Hydroxy butyryl Coenzyme A, Hydroxy-3-methylglutaryl Coenzyme A, Isobutyryl Coenzyme A, Lauroyl Coenzyme A, Lignoceryl Coenzyme A, Linoleoyl Coenzyme A, Malonyl Coenzyme A, Methylmalonyl Coenzyme A, Myristoyl Coenzyme A, Nonadecanoyl Coenzyme A, Octanoyl Coenzyme A, Oleoyl Coenzyme A, Palmitoyl Coenzyme A, Propionyl Coenzyme A, Stearoyl Coenzyme A, and Succinyl-CoA.

10. The method of claim 6 wherein the chromatographic separation is performed by at least one of the chromatographic methods selected from the group consisting of parallel liquid chromatography (LC), multiplexed LC, super-critical fluid chromatography, and serial LC.

11. The method of claim 6 wherein the chromatographic separation is performed by at least one chromatographic method selected from the group consisting of parallel LC, multiplexed LC, super-critical fluid chromatography, and serial LC, in combination with at least one of the detection systems selected from the group consisting of mass spectrometry (MS), tandem mass spectrometry (MS/MS), high resolution mass spectrometry (HRMS), radioactive detection, and fluorescent detection, and wherein the resulting chromatography/detection system is run in multiple parallel chromatography/detection systems.

12. (canceled)

13. The method of claim 1 wherein the substrate or substrate product for target screened for activity is CoA or a CoA-conjugate.

14. The method of claim 13 wherein the CoA conjugate is selected from the group consisting of Coenzyme A (CoA, CoASH, HSCoA), Acetyl-CoA, Arachidonyl Coenzyme A, Butyryl Coenzyme A, Crotonyl Coenzyme A, Decanoyl coenzyme A, Docosanoyl Coenzyme A, Eicosatrienoyl 8,11,14 Coenzyme A, Heptadecanoyl Coenzyme A, Hexacosanoyl Coenzyme A, Hexanoyl Coenzyme A, Hydroxy butyryl Coenzyme A, Hydroxy-3-methylglutaryl Coenzyme A, Isobutyryl Coenzyme A, Lauroyl Coenzyme A, Lignoceryl Coenzyme A, Linoleoyl Coenzyme A, Malonyl Coenzyme A, Methylmalonyl Coenzyme A, Myristoyl Coenzyme A, Nonadecanoyl Coenzyme A, Octanoyl Coenzyme A, Oleoyl Coenzyme A, Palmitoyl Coenzyme A, Propionyl Coenzyme A, Stearoyl Coenzyme A, and Succinyl-CoA.

15. The method of claim 1 wherein the chromatographic separation is performed by at least one chromatographic method selected from the group consisting of parallel LC, multiplexed LC, super-critical fluid chromatography, and serial LC.

16. The method of claim 1 wherein the chromatographic separation is performed by at least one chromatographic method selected from the group consisting of parallel LC, multiplexed LC, super-critical fluid chromatography, and serial LC, in combination with at least one detection system selected from the group consisting of mass spectrometry (MS), tandem mass spectrometry (MS/MS), high resolution mass spectrometry (HRMS), radioactive detection, and fluorescent detection, and wherein the resulting chromatography/detection system is run in multiple parallel chromatography/detection systems.

17. The method of claim 1, further comprising the step of processing said drug candidate through at least one cell-based screening assay.

18. The method of claim 17, wherein said drug candidate is screened for activity against a therapeutic target selected from the group consisting of neurological targets, infectious disease targets, diabetes targets, and obesity targets.

19. The method of claim 10, wherein sample loading is staggered injection loading.

20. The method of claim 15, wherein sample loading is staggered injection loading.
